(19) United States
(12) Patent Application Publication
(10) Pub. No.: US 2010/0322701 A1
(43) Pub. Date: Dec. 23, 2010

(54) NOVEL MODIFICATION OF PLASTIC LAY-FLAT BINDING COMB

(75) Inventors: PAUL M. BUTTERFIELD, ONTARIO, NY (US); HENRY T. KREMERS, FAIRPORT, NY (US)

Correspondence Address: XEROX CORPORATION;Attn: Law Offices of James J. Ralabate, Patent Documentation Center, 100 Clinton Ave South, MS: XRX2-020, Rochester, NY, 14644, US

(73) Assignee: XEROX CORPORATION, NORWALK, CT (US)

(21) Appl. No.: 12/487,295

(22) Filed: Jun. 18, 2009

(51) Int. Cl. B42F 13/02

(52) U.S. Cl. 402/19

(57) ABSTRACT

This is a sheet binder or comb configured for use in lay-flat binding technology. This comb allows two- or three-ring binding of finished comb-bound booklets by the addition of a like number of round holes stamped into the comb. Obviously, any number of round holes can be used to accommodate two or more ring binders.

This invention relates to a plastic spine binder or comb for securing a stack of sheets of paper or the like. More specifically, the invention relates to a spine binder that can be used in a two, three or larger ring binder or notebook.

### BACKGROUND

General Binding Corporation (GBC) has developed an innovative lay-flat binding technology that uses adhesive and a plastic “comb.” Because the binding technology can be automated, it is a tremendous improvement over the more traditional coil binding system. However, the design of the plastic “comb” precludes concurrent inclusion of holes for two or three-ring binding systems, or binding systems having more than 3 rings. The comb technology provides that the spine of the comb is “hidden” inside the document, usually inside the back cover. It is solid in the area where three-ring holes used in this invention would need to be. Some customers want both the automation possible with the plastic comb technology and the ability to capture multiple comb-bound booklets into a two- or three-ring binder. Because of its incompatibility with two- or three-ring binding, the technology is a non-starter for some customers, and they are relegated to the prior art laborious spiral bind system.

A GBC (a trademark of General Binding Corporation) in a User Guide explains how the plastic comb or e Binder 200 is used with specifications, features, and benefits outlined therein. This User Guide is identified as Version 1.0, Jan. 30, 2009 Rev. 1, GBC Doc. #7709016. This User Guide is incorporated by reference into the present disclosure.

The GBC e Binder 200 in one embodiment is used in Xerox high speed marking machine or systems. Documents flow directly from the marking machine to a binding system avoiding the bottleneck associated with other traditional off-line processes. This GBC binding system affords superior turnaround times and significantly reduces labor costs. Generally, only one operator is required to print, punch, and bind documents. In some Xerox marking machines, this GBC system provides combining printing, paper punching, collating and binding into one convenient system. It helps create books that lie flat and creates a more stable document that takes up less space when shipping, stacking, and storing.

With all of the advantages of the above-binding system, some customers want both the automation possible with this plastic comb technology and the ability to capture multiple comb-bound booklets into a two- or three-ring binder or notebook. Since the binder is incompatible with these two- or three-ring binding or notebooks, a system that provides for both uses would be commercially desirable.

### SUMMARY

The present invention is a modification of the plastic “comb” that would allow two-, three- (or more rings) binding of finished comb-bound booklets and the addition of two- or three-hole punch to the die used in the GBC finishing technology. The comb modification would require removal of the comb's middle “finger” and addition of at least two round holes to accommodate, for example, a three-ring binder.

The present invention makes the presently used comb structure to be conveniently modified so that the resulting booklets, books, reports, surveys, sales presentations and other compilations can be collected and used in two- or three-ring binders. When the terms “two or three ring” binders are used in this disclosure and claims, more than three rings are also intended.

Plastic comb binding is a piece of plastic with “teeth” that fit into rectangular pre-punched holes in the paper. It allows your documents to lay flat when opened. Comb binding is an inexpensive but a professional looking option. Continuous plastic fingers pass through many little pre-punched holes along one side edge of the papers. Because the plastic finger is threaded through all the holes, it is generally less expensive than prior art double loop wire binding.

Prior art coil and wire binding methods are not as desirable since they require additional finishing time. Pages must be punched with the proper pattern of multiple holes before binding. Because only a few pages at a time can be punched, and they must all line up correctly, it adds to the preparation time.

Combs are generally available in fifteen diameters, from ¼″ through 2″. Comb binding requires comb and paper punching and binding equipment. Easy-to-use equipment is available for comb binding, both manual and electric models.

In the present invention, the punching of holes in the document (except for the embodiment of FIG. 5) is necessary for the resulting use in three-ring or other binding operation. The manufacture of the comb binder in all embodiments of this invention can include a step or steps of punching the holes in the spine of the binder to accommodate use in two- or three- or more ring binders.

### BRIEF DESCRIPTION OF THE DRAWINGS

FIG. 1 illustrates a plan view of a prior art unmodified comb or spine binder.

FIG. 2 illustrates a plan view of a three hole modified comb of the present invention.

FIG. 3 illustrates a plan view of a paper stack that is modified to be used with the three-hole comb of the present invention.

FIG. 4 illustrates a plan view of the three-hole modified v-comb of this invention in place as it binds documents to form a booklet.

FIG. 5 illustrates a three hole embodiment of the present invention as it is swung out from the paper edge ready to accept three-hole binder rings.

FIG. 6 illustrates a two-hole modified comb of the present invention.

### DETAILED DISCUSSION OF DRAWINGS AND PREFERRED EMBODIMENTS

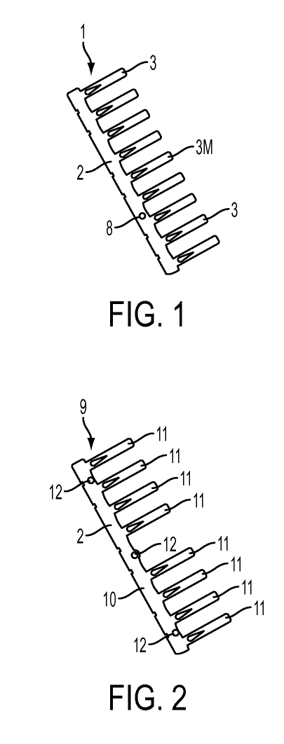

In FIG. 1 a prior art spindle binder or comb 1 is illustrated as it is unmodified by the present invention. The comb has a flat spine or dorsal 2 with a plurality of flexible fingers 3 extending outwardly from the spine 2. The fingers include a middle finger 3m. These fingers 3 are inserted into prepunched holes 5 placed in paper 4 of a stack of paper to be bound. After the fingers 3 are placed through each corresponding hole 5 in the stack, they are bent around the edge 6 of the paper and adhered to the flat spine 2 with an appropriate adhesive 7. A hole 8 in the prior art comb 1 is used only to align the comb 1 during the manufacture process. The comb 1 is usually hidden inside the back cover of the bound document.

Some customers want to use this prior art comb 1 and the ability to capture multiple comb bound booklets into a two or three ring binder. Because the prior art comb 1 has no accommodation for use in two or three ring binders, it is not possible to use multiple comb-bound stacks in such binders. Although this disclosure and claims will discuss two-and three-ring binders, it is intended that any binder or notebook with two or more rings can use the present invention.

In FIG. 2 a three-hole modified comb 9 of the present invention is illustrated. It has a spine 10 and a plurality of flexible fingers 11 which operate or are used in bind stacking as the prior art comb 1 of FIG. 1, except the bound booklets can not be used or collected in a three- (or more than 2) ring binder. To accommodate use of multiple bound booklets in a three- (or more) ring binder, three holes 12 are punched into the modified comb 9 and a middle prior art finger 3M (see FIG. 1) is removed. Three holes 12 corresponding to rings of ring binders are punched into the comb 9 during manufacturing of the comb 9. Also as holes 5 are punched in paper to accept the fingers 11, additional round holes 13 are punched in the paper 4 to accommodate three-ring binders. The appropriate number of holes 13 are punched into paper 4 to accommodate two or more ring binders of this invention; i.e., four holes to accommodate four ring binders, five holes to accommodate five ring binders, etc.

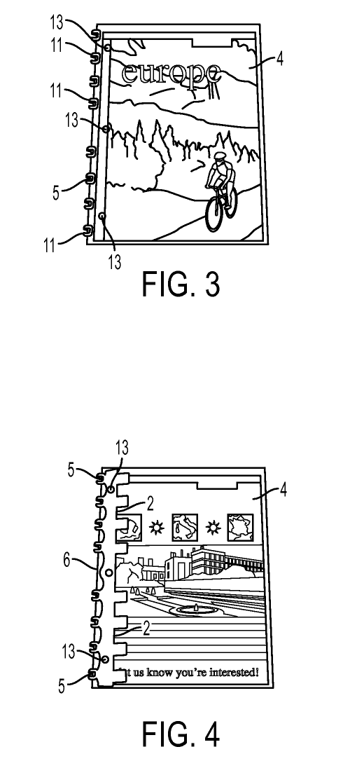

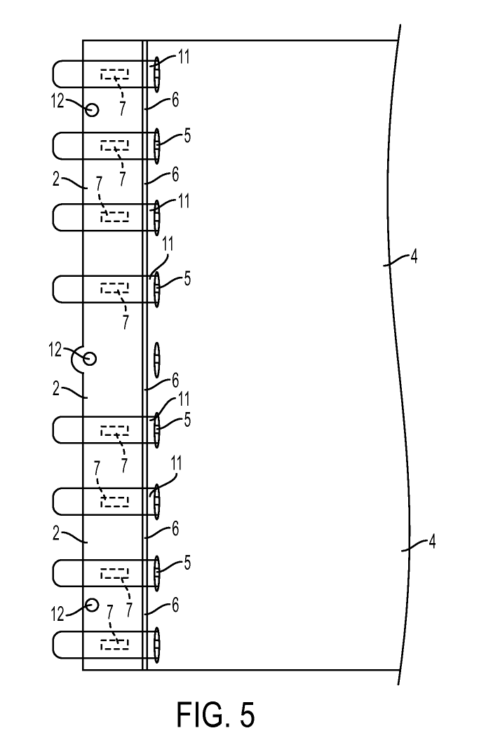

In FIG. 3, an embodiment of the comb 9 of this invention is shown with fingers 11 in place as it binds a booklet or paper stack 4. The flexible fingers 11 fit through holes 5 punched into the paper 4 to accept fingers 11. In addition, round holes 13 in this embodiment are punched into the paper 4 so as to accommodate and align with the three holes 12 punched into the comb 9. The three rings of the three-ring binder will bend and fit through comb holes 12 and paper holes 5 when used in a three-ring binder. Once the fingers 11 are placed through holes 5 they are connected to flat spine 2 by an adhesive 7 as shown in FIG. 4. Spine 10 of this invention in one embodiment can swing outwardly away from paper edge 6 so that the spine portion containing the three holes 13 are available for attachment to three-ring binders as shown in FIG. 5. The location of the comb 9 is shown in place in a back portion of the paper or booklet 4, usually inside the back cover of the booklet 4.

In FIG. 5 the spine 10 is shown as it is swung outwardly away (about 180 degrees movement from its original position as shown in FIG. 4) from the paper edge 6 for attachment to a three-ring binder. In this embodiment, it is not necessary to punch round holes 13 in the paper since only holes 12 in the spine 10 are necessary for connection to a three-ring binder.

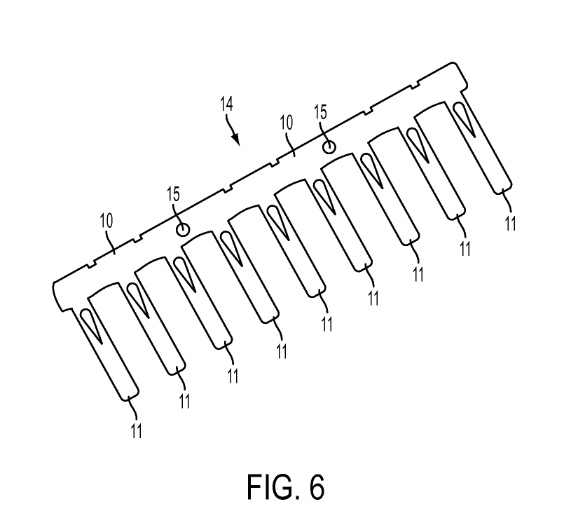

In FIG. 6 a two hole modification 14 and embodiment of this invention is illustrated. Only two holes 15 are needed for attachment to a two-hole binder in the same manner as described in FIGS. 2-5 regarding a three-hole modification. In the two hole modification 14, it is not necessary to remove finger 3M of the prior art. Otherwise, the two hole embodiment 14 works as does the three hole embodiment 9 of the above described in FIGS. 2-5. Any suitable number of holes 15 may be used that are greater than 2. Thus, at least two holes 15 useful for attachment to an equal number of rings of a ring binder are within the spirit of this invention.

In summary, embodiments of this invention provide a spine binder comb for securing a stack of sheets together. The comb comprises a spine or dorsal part, a plurality of flexible fingers extending from and attached to the spine which are configured to fit through holes in the sheets when connecting them to form a booklet. The spine has therein at least two round holes configured to accommodate connection to a ring binder having a like number of connection rings. The comb is constructed of a substantially flexible plastic material. In one embodiment, the spine contains three round holes to accommodate a three-ring binder, and in another embodiment the spine contains two round holes to accommodate a two-hole binder. At least two holes are used to accommodate a like number of binder rings. The spine is bar-like having a substantially flat surface and configured for use in lay-flat bindings where the fingers are attached to the flat spine by an adhesive. Of course, this is after the fingers have been fitted through the paper holes in the paper stack. Thus, the comb is configured to have fingers placed through holes in the sheets for connection of the sheets together. The fingers, as above noted, are configured to be connected by an adhesive to the flat spine subsequent to this connection.

In one preferred embodiment, the comb is configured to be swung away from an outer edge of the sheets to provide thereby access to the round holes for a ring binder with a like amount of holes. The comb in one embodiment has three round holes and is configured for use with a three hole binder. A middle hole of the three round holes is positioned in an outwardly extending middle portion of the spine. The present invention includes a bound stack of sheets or booklet comprising a bound stack of sheets having a fixed number of holes punched therein and a spine binder or comb having a plurality of flexible fingers.

The plurality of flexible fingers are equal to a number of the holes punched in the sheets. The comb comprises a spine or dorsal part and the fingers extend from this spine. The spine has therein at least two round holes to accommodate connection of the bound stack of sheets to a ring binder having rings equal to the number of round holes located in the spine. In the booklet, the comb is constructed of a substantially flexible plastic material. As earlier noted, the spine contains three round holes to accommodate a three-ring binder in one embodiment and in another embodiment the spine contains two round holes to accommodate a two-hole binder. The spine is bar-like having a substantially flat surface and is configured for use in lay-flat bindings. The fingers of the booklet are placed through holes in the sheets for connection of the sheets together. The fingers are configured to be connected by an adhesive to the spine subsequent to the connection. The booklet has a comb that in one embodiment is configured to be swung away from an outer edge of the sheets to provide thereby access of the round holes to an equal or like ring binder. The booklet in one embodiment has three round holes and is configured for use with a three-hole binder. A middle hole of the three round holes is positioned in an outwardly extending middle portion of the spine. The fingers have free front ends configured for entrance and engagement with the pre-punched holes in the sheets and are configured to be attached to the spine by an adhesive after this engagement with the holes.

It will be appreciated that variations of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A spine binder comb for securing a stack of sheets together, said comb comprising:
a spine or dorsal part,
a plurality of flexible fingers extending from and attached to said spine,
said fingers configured to fit through holes in said sheets when connecting them to form a booklet,
said spine having therein at least two round holes configured to accommodate connection to a ring binder having a like number of connection rings.

2. The comb of claim 1 wherein said comb is constructed of a substantially flexible plastic material.

3. The comb of claim 1 wherein said spine contains three round holes to accommodate a three-ring binder.

4. The comb of claim 1 wherein said spine contains two round holes to accommodate a two-hole binder.

5. The comb of claim 1 wherein said spine is bar-like having a substantially flat surface and is configured for use in lay-flat bindings.

6. The comb of claim 1 configured to have said fingers placed through holes in said sheets for connection of said sheets together, said fingers configured to be connected by an adhesive to said spine subsequent to said connection.

7. The comb of claim 1 configured to be swung away from an outer edge of said sheets to provide thereby access to and of a said round holes to an equal or like ring binder.

8. The comb of claim 1 having three round holes and configured for use with a three-hole binder, a middle hole of said three round holes positioned in an inside extending middle portion of said spine.

9. A bound stack of sheets or booklet comprising:
a bound stack of sheets having a fixed member of holes punched therein, and
a spine binder or comb having a plurality of flexible fingers,
said plurality of flexible fingers equal to a number of said holes punched in said sheets,
said comb comprising a spine or dorsal part,
said fingers extending from said spine,
said spine having therein at least two round holes to accommodate connection of said bound stack of sheets to a ring binder having rings equal to the number of round holes located in said spine.

10. The booklet of claim 9 wherein said comb is constructed of a substantially flexible plastic material.

11. The booklet of claim 9 wherein said spine contains three round holes to accommodate a three-ring binder.

12. The booklet of claim 9 wherein said spine contains two round holes to accommodate a two-hole binder.

13. The booklet of claim 9 wherein said spine is bar-like having a substantially flat surface and configured for use in lay-flat bindings.

14. The booklet of claim 9 configured to have said fingers placed through holes in said sheets for connection of said sheets together, said fingers configured to be connected by an adhesive to said spine subsequent to said connection.

15. The booklet of claim 9 configured to be swung away from an outer edge of said sheets to provide thereby access to and of said round holes to an equal or like ring binder.

16. The booklet of claim 9 having three round holes and configured for use with a three-hole binder, a middle hole of said three round holes positioned in an inside extending middle portion of said spine.

17. The booklet of claim 9 wherein said fingers have free front ends configured for entrance and engagement with said holes in said sheets and configured to be attached to said spine by an adhesive after said engagement with said holes.
